(19) United States
(12) Patent Application Publication
(10) Pub. No.: US 2021/0326326 A1
(43) Pub. Date: Oct. 21, 2021

(54) PROOF AGGREGATING SYSTEM FOR ASSET MANAGEMENT TRACEABILITY BASED ON BLOCKCHAIN AND METHOD THEREOF

(71) Applicant: Skychain CO., LTD., Taipei City (TW)

(72) Inventors: Chen-Hsuan WANG, Taipei City (TW); Jiann-Min YANG, Taipei City (TW); Scott MIAU, Taipei City (TW)

(21) Appl. No.: 17/232,169

(22) Filed: Apr. 16, 2021

(30) Foreign Application Priority Data
Apr. 16, 2020 (TW) 109112741

(51) Int. Cl. G06F 16/23; G06F 16/27

(52) U.S. Cl. CPC G06F 16/2365; G06F 16/27

(57) ABSTRACT

A proof aggregating system for asset management traceability based on blockchain and a method thereof are disclosed. In the system, a creator host deploys a smart contract associated with an asset on a blockchain network through, so as to aggregate a proof value of digital file associated with the asset for further verification and management; a holder host executes an authorization function to set a writer host to be permitted to access the smart contract, the writer host calculates a proof value based on the digital file associated with the asset, and executes a write function to write the proof value into a proof record of the smart contract, so as to provide a verification host to verify the aggregated proof record. As a result, the technical effect of improving authenticity and credibility of the asset management traceability can be achieved.

### CROSS-REFERENCE TO RELATED APPLICATIONS

The present application is based on, and claims priority from, Taiwan Application Serial Number 109112741, filed Apr. 16. 2020, the disclosure of which is hereby incorporated by reference herein in its entirety.

### BACKGROUND

### 1. Technical Field

The present invention relates to a proof aggregating system and a method thereof, more particularly to a proof aggregating system for asset management traceability based on blockchain and a method thereof.

### 2. Description of Related Arts

In recent years, with the popularization and vigorous development of electronicization, various asset management methods have developed toward paperless, electronic, or digitalized development. For example, the repair records, inspection reports, appraisal and maintenance documents, which are provided and stored as papers in prior art, are gradually provided and stored as electronic files.

Generally speaking, conventional asset management methods usually use a database to add, modify, or delete various pieces of information related to assets including tangible assets and intangible assets, for example, the information may include usage histories, sales/production/maintenance records, electronic warranty, electronic warranty cards, etc. However, electronic files may be easily copied, tampered, deleted. Therefore, how to ensure the authenticity of the electronic file has become one of the problems that manufacturers urgently want to solve.

For this reason, some manufacturers have proposed a technical solution using electronic signature, and the authenticity and credibility of the electronic file signed by the electronic signature. However, this method is workable only when the private key used for signature is stored in a secure state, and if the private key is stolen, copied or cracked, the electronic document signed with this private key will no longer be authentic and credible, and it causes an adverse effect on asset management. Therefore, the above-mentioned conventional method is still unable to effectively solve the problem of insufficient authenticity and credibility in asset management.

Therefore, what is needed is to develop an improved technical solution to solve the problem that the insufficient authenticity and credibility in the asset management.

### SUMMARY

An objective of the present invention is to provide a proof aggregating system for asset management traceability based on blockchain and a method thereof, so as to solve the conventional technical problem.

In order to achieve the objective, the present invention discloses a proof aggregating system for asset management traceability based on blockchain. The proof aggregating system is applied to a blockchain network formed by a plurality of node hosts, and includes a creator host, a writer host and a verification host. The creator host serves as one of the plurality of node hosts and includes a deploy module and a setting module. The deploy module is configured to deploy an asset smart contract associated with an asset on the blockchain network through a blockchain transaction. The asset smart contract includes an authorization function and a write function and configured to record a proof value conversion manner, holder information, and a plurality of proof records. The setting module is configured to write asset information into the asset smart contract and set an address of the creator host in the holder information, and then update the address recorded in the holder information when the asset is delivered to a holder.

The writer host serves as one of the plurality of node hosts and is configured to perform calculation on at least one digital file, which is associated with the asset, to generate a first proof value, and then execute the write function to write the first proof value corresponding to the at least one digital file into the proof record of the asset smart contract. The holder host serves as one of the plurality of node hosts and is configured to execute the authorization function to store an address of the writer host into the asset smart contract. When a preset writable condition is satisfied, the asset smart contract permits the writer host to write the at least one first proof value corresponding to the asset into the proof record. The verification host serves as one of the plurality of node hosts and is configured to receive the at least one digital file associated with the asset, and execute the same proof value conversion manner on the received digital file, to calculate at least one second proof value. When the second proof value is different from the first proof value, the verification host outputs a warning message.

In order to achieve the objective, the present invention further discloses a proof aggregating method for asset management traceability based on blockchain. The proof aggregating method is applied to a blockchain network formed by a plurality of node hosts, and the proof aggregating method includes steps of: providing a creator host, a holder host, a writer host and a verification host, wherein each of the creator host, the holder host, the writer host and the verification host serves as one of the plurality of node hosts; using the creator host to deploy an asset smart contract associated with an asset on the blockchain network through a blockchain transaction, wherein the asset smart contract comprises an authorization function and a write function, and records a proof value conversion manner, holder information, and a plurality of proof records; using the creator host to write asset information into the asset smart contract and set an address of the creator host in the holder information, and then update the holder information to an address of the holder host when the asset is delivered to a holder; using the holder host to execute the authorization function to store an address of the writer host to the asset smart contract, wherein when a preset writable condition is satisfied, the asset smart contract permits the writer host to write at least one first proof value corresponding to the asset into the proof record; using the writer host to perform calculation on at least one digital file associated with the asset to generate the at least one first proof value, and execute the write function to write the at least one first proof value corresponding to the at least one digital file into the proof record of the asset smart contract; when the verification host receives the digital file associated with the asset, using the verification host to execute the same proof value conversion manner on the received digital file to calculate at least one second proof value, and output a warning message when the at least one second proof value is different from the at least one first proof value.

According to above-mentioned system and method, the difference between the present invention and conventional technology is that in the present invention, the creator host can deploy the smart contract associated with the asset on the blockchain network, so as to aggregate the proof value of the digital file associated with the asset for further verification and management, the holder host can execute the authorization function to set the writer host to be permitted to access the smart contract, and the writer host can calculate the proof value based on the digital file associated with the asset and execute the write function to write the proof value into the proof record of the smart contract, so as to provide the verification host to verify the aggregated proof record.

By aforementioned technical solution, the present invention can achieve the technical effect of improving authenticity and credibility of asset management.

### BRIEF DESCRIPTION OF THE DRAWINGS

The structure, operating principle and effects of the present invention will be described in detail by way of various embodiments which are illustrated in the accompanying drawings.

FIG. 1 is a system block diagram of a proof aggregating system for asset management traceability based on blockchain, according to the present invention.

FIGS. 2A to 2D are flowcharts of a proof aggregating method for asset management traceability based on blockchain, according to the present invention.

FIG. 3 is a schematic view of a first embodiment to which the present invention is applied.

FIG. 4 is a schematic view of a second embodiment to which the present invention is applied.

FIG. 5 is a schematic view of a third embodiment to which the present invention is applied.

FIG. 6 is a schematic view of a fourth embodiment to which the present invention is applied.

FIG. 7 is a schematic view of a fifth embodiment to which the present invention is applied.

### DETAILED DESCRIPTION

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims.

These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts. As used herein, the singular forms “a”, “an” and “the” are intended to include the plural forms as well, unless the context clearly indicates otherwise.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the words “comprise” and “include”, and variations such as “comprises”, “comprising”, “includes”, or “including”, will be acknowledged to imply the inclusion of stated elements but not the exclusion of any other elements.

The implementation of the present invention will be illustrated in detail with reference to the accompanying drawings and embodiment, so that the implementation process of applying the technical solution of the present invention to solve technical problem and achieve technical effect will be readily apparent as the same becomes better understood for implementation.

The terms defined in the present invention are described before the description of the proof aggregating system for asset management traceability based on blockchain and method thereof of the present invention. The term “asset smart contract” of the present invention means the smart contract deployed on the blockchain network. In fact, the smart contract means a computer program for driving execution commands based on a predetermined condition and transferred information, and particularly, the smart contract is programmed with programming language, such as Solidity, Serpent, LLL, EtherScript, or Sidechain, and the smart contract can include different functions, events and parameter states; for example, in Ethereum environment, a smart contract is compiled to obtain binary codes and an application binary interface (ABI), so as to broadcast the smart contract to the blockchain network and wait for a miner or a validator to deploy the smart contract in the blockchain to obtain a corresponding address, which is also called a contract address; so far the smart contract is completely deployed through the blockchain transaction. Next, each node host can execute the smart contract based on the corresponding address, and change a state of the smart contract in the blockchain by different command and detect whether an event is triggered.

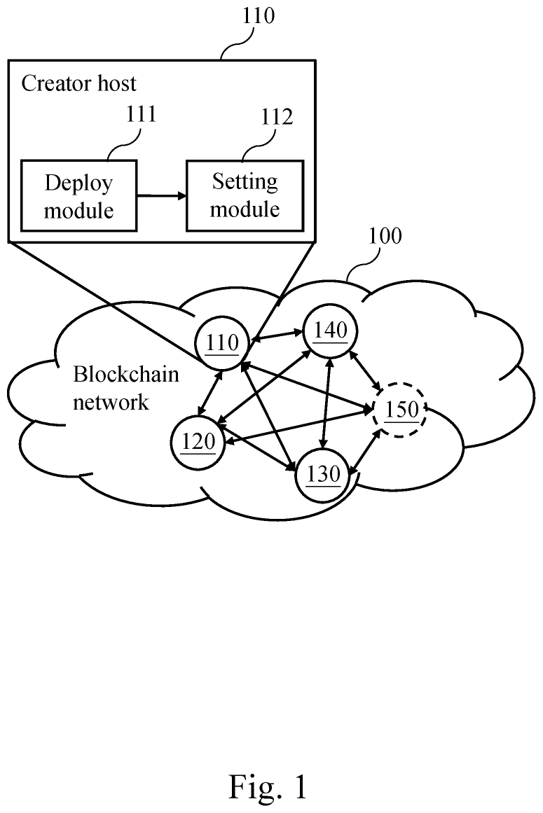

The proof aggregating system for asset management traceability based on blockchain and a method thereof of the present invention will hereinafter be described in more detail with reference to the accompanying drawings. Please refer to FIG. 1, which is a system block diagram of a proof aggregating system for asset management traceability based on blockchain, according to the present invention. As shown in FIG. 1, the proof aggregating system is applied to a blockchain network 100 which is formed by a plurality of node hosts, and the proof aggregating system includes a creator host 110, a writer host 120, a holder host 130 and a verification host 140. The creator host 110 serves as one of the node hosts and includes a deploy module 111 and a setting module 112. The deploy module 111 is configured to deploy an asset smart contract, which is associated with an asset, on the blockchain network 100 through a blockchain transaction. The asset smart contract includes an authorization function and a write function and records a proof value conversion manner, holder information, and a plurality of proof records. In actual implementation, the asset smart contract includes a transfer function. and the holder host 130 can be permitted to execute the transfer function to change the holder information recorded in the asset smart contract, for example, the holder information can include a new address of the holder host 130. Besides, the creator host 110 can use at least one of an RFID reader, a laser etching device, a printing device and a magnetic device and so on, to embed an address of the asset smart contract in an RFID tag, a laser tag, a linear bar code, a two-dimensional barcode, a serial number or a magnetic strip of the asset, so that the verification host 140 can obtain the address of the asset smart contract by using a RFID sensor, a scanner, a magnetic sensor or a direct input manner, so as to read a first proof value in the proof record of the asset smart contract and then compare the read first proof value with a second proof value calculated by the verification host 140, and then determine whether the proof is credible based on a comparison result; if the first proof value and the second proof value are different from each other, it indicates that the proof is not credible, and the verification host 140 outputs a warning message, such as a text message, to show that the proof is not credible. Furthermore, the proof value conversion manner includes first calculating the digital file by Base64 coding, and then executing a hash function to perform hash, and based on a size or type or the digital file, selecting one of using raw data, compression algorithm, symmetric encryption, asymmetric encryption and a combination thereof. It is to be particularly noted that the writer host 120 and the verification host 140 must use the same proof value conversion manners to calculate the above-mentioned proof values.

The setting module 112 is configured to write asset information into the asset smart contract, and set an address of the creator host 110 into the holder information, and then update the address recorded in the holder information when the asset is delivered to a holder, for example, the address is updated to the address of the holder host 130. In actual implementation, the asset information can be an identifier having uniqueness, for example, the asset information can be a universally unique identifier, a globally unique identifier or any unique information. In a condition that the asset is a machine, the asset information can be machine identification information, such as the unique production serial number or code; when the machine is delivered to a holder, the address of the creator host 110 recorded in the holder information is updated to an address of the holder host 130, and the address refers to the address corresponding to a private key of a node host in the blockchain network 100, for example, the address can be “0x46f . . . . . . ”.

The writer host 120 serves as one of the node hosts and configured to perform calculation on the digital file associated with the asset, so as to generate a first proof value, and the writer host 120 then executes the write function to write the first proof value corresponding to the digital file into the proof record of the asset smart contract. The digital file associated with the asset can include a contract, an inspection report, a maintenance record, a detection record, a sensing record, an appraisal record or a medical record. These digital files can be first coded by Base64, and hash calculation is performed on the coded result to generate a proof value. For convenience in explanation and differentiation, the proof value calculated by the writer host 120 is regarded as a first proof value, the proof value generated by the verification host 140 by the same manner is regarded as a second proof value, and a proof value (mentioned later) generated by a second writer host 150 by the same manner is regarded as a third proof value.

The holder host 130 serves as one of the node hosts and executes an authorization function to store the address of the writer host 120 into the asset smart contract. When the asset smart contract satisfies a preset writable condition, the writer host 120 is permitted to write the first proof value corresponding to the asset into the proof record. For example, the writable condition includes a writable time range or writable times. In actual implementation, the writable condition can be set by the holder host 130, for example, in a condition that the asset is a machine and the application scenario is monthly safety inspection, a number of the writable times in a year can be set as a value of 12; in a condition that the asset is a vehicle and the application scenario is one-time maintenance, a number of the writable times for one day or several days can be set as a value of 1.

The verification host 140 serves as the one of the node hosts. When receiving the digital file associated with the asset, the verification host 140 executes the same proof value conversion manner on the received digital file, to calculate a second proof value, that is, the proof value conversion manner executed by the verification host 140 is the same as that executed by the writer host 120. When the second proof value is different from the first proof value, the verification host 140 outputs a warning message, such as a text message showing that the proof is not credible. In actual implementation, in a condition that the writer host 120 uses Base64 and message-digest algorithm 5 (MD5) to calculate the first proof value based on the configuration in the proof value conversion manner, the verification host 140 must also use Base64 and MD5 to calculate the second proof value based on the configuration in the proof value conversion manner.

It is to further explain that the proof aggregating system for asset management traceability based on blockchain of the present invention includes a second writer host 150 serving as one of the node hosts, and the second writer host 150 can calculate a third proof value based on the digital file, and then execute a check function of the asset smart contract to write the third proof value into the asset smart contract as a check record for the verification host 140 to check. In actual implementation, the writer host 120 and the second writer host 150 execute the same processes, and the difference is that the writer host 120 calculates the first proof value based on the digital file to generate the proof record, the second writer host 150 calculates the third proof value in the same way based on the same digital file, to generate the check record. When the first proof value is equal to the third proof value, it indicates that no error occurs; otherwise, when the first proof value is different from the third proof value, it indicates that an error occurs in at least one of the proof record and the check record. In other words, when the same processes are executed but the generated proof values are different from each other, it indicates that at least one problem occurs, so the verification host determines whether the proof is authentic and credible according to whether the proof record and the check record are the same.

It is to be particularly noted that, in actual implementation, the modules of the present invention can be implemented by various manners, including software, hardware or any combination thereof; for example, in an embodiment, the module can be implemented by software and hardware, or one of software and hardware. Furthermore, the present invention can be implemented fully or partly based on hardware, for example, one or more module of the system can be implemented by integrated circuit chip, system on chip (SOC), a complex programmable logic device (CPLD), or a field programmable gate array (FPGA). The concept of the present invention can be implemented by a system, a method and/or a computer program. The computer program can include computer-readable storage medium which records computer readable program instructions, and the processor can execute the computer readable program instructions to implement concepts of the present invention. The computer-readable storage medium can be a tangible apparatus for holding and storing the instructions executable of an instruction executing apparatus. The computer-readable storage medium can be, but not limited to electronic storage apparatus, magnetic storage apparatus, optical storage apparatus, electromagnetic storage apparatus, semiconductor storage apparatus, or any appropriate combination thereof. More particularly, the computer-readable storage medium can include a hard disk, a RAM memory, a read-only-memory, a flash memory, an optical disk, a floppy disc or any appropriate combination thereof, but this exemplary list is not an exhaustive list. The computer-readable storage medium is not interpreted as the instantaneous signal such a radio wave or other freely propagating electromagnetic wave, or electromagnetic wave propagated through waveguide, or other transmission medium (such as electric signal transmitted through electric wire), or optical signal transmitted through fiber cable). Furthermore, the computer readable program instruction can be downloaded from the computer-readable storage medium to each calculating/processing apparatus, or downloaded through network, such as internet network, local area network, wide area network and/or wireless network, to external computer equipment or external storage apparatus. The network includes copper transmission cable, fiber transmission, wireless transmission, router, firewall, switch, hub and/or gateway. The network card or network interface of each calculating/processing apparatus can receive the computer readable program instructions from network, and forward the computer readable program instruction to store in computer-readable storage medium of each calculating/processing apparatus. The computer program instructions for executing the operation of the present invention can include source code or object code programmed by assembly language instructions, instruction-set-structure instructions, machine instructions, machine-related instructions, micro instructions, firmware instructions or any combination of one or more programming language. The programming language include object oriented programming language, such as Common Lisp, Python, C++, Objective-C, Smalltalk, Delphi, Java, Swift, C#, Perl, Ruby, and PHP, or regular procedural programming language such as C language or similar programming language. The computer readable program instruction can be fully or partially executed in a computer, or executed as independent software, or partially executed in the client-end computer and partially executed in a remote computer, or fully executed in a remote computer or a server.

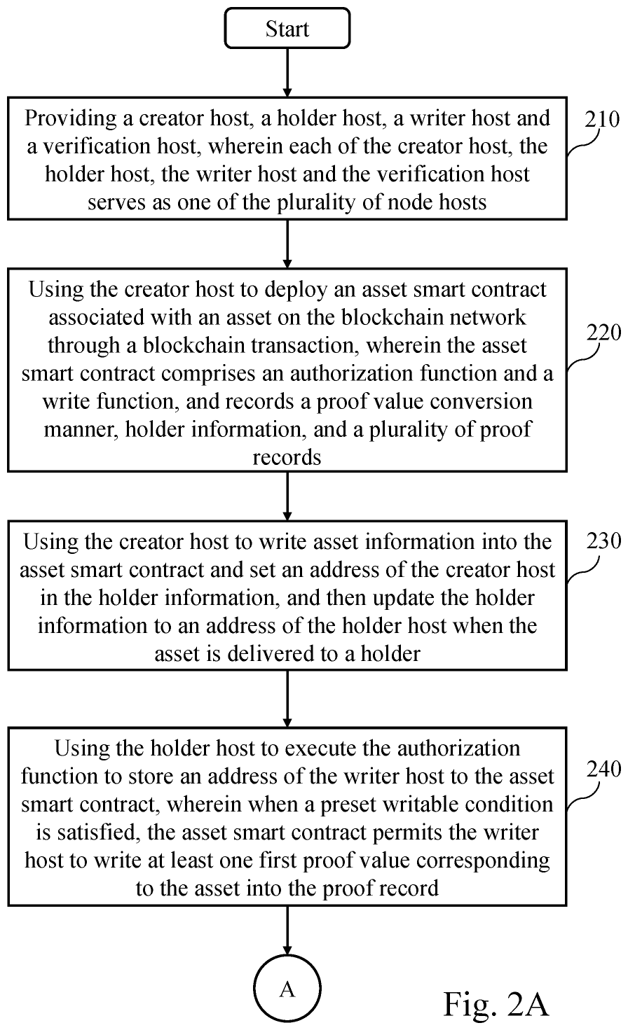

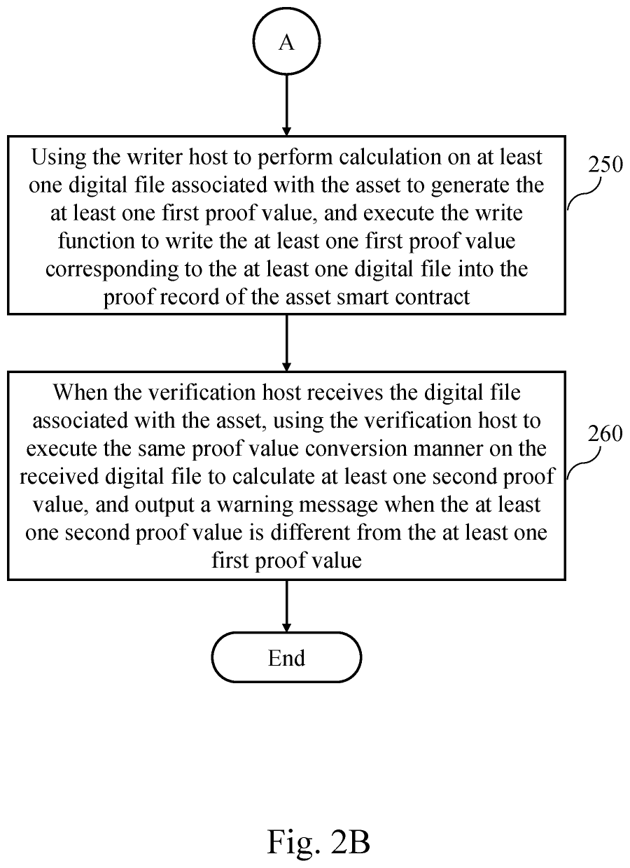

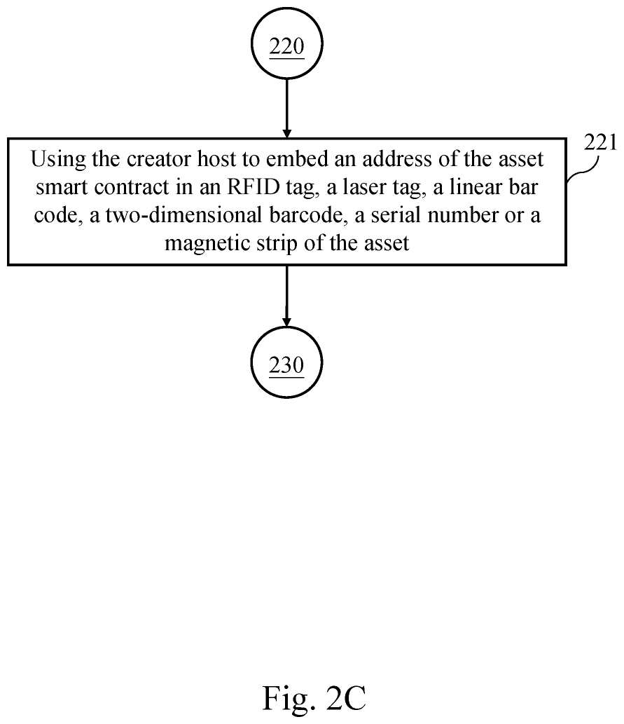

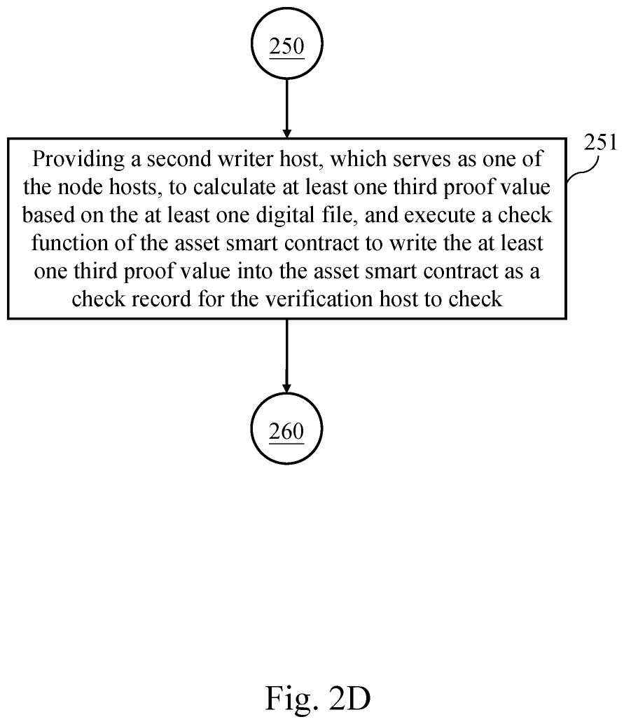

Please refer to FIGS. 2A to 2D, which are flowcharts of a proof aggregating method for asset management traceability based on blockchain, according to the present invention. As shown in FIGS. 2A to 2D, the proof aggregating method is applied to the blockchain network 100 formed by the plurality of node hosts, and the proof aggregating method includes steps 210 to 260. In a step 210, a creator host, a holder host, a writer host and a verification host are provided, and each of the creator host, the holder host, the writer host and the verification host serves as one of the plurality of node hosts. In a step 220, the creator host deploys an asset smart contract associated with an asset on the blockchain network through a blockchain transaction, and the asset smart contract includes an authorization function and a write function, and records a proof value conversion manner, holder information, and a plurality of proof records. In a step 230, the creator host writes asset information into the asset smart contract and sets an address of the creator host in the holder information, and then updates the holder information to an address of the holder host when the asset is delivered to a holder. In a step 240, the holder host executes the authorization function to store an address of the writer host to the asset smart contract, and when a preset writable condition is satisfied, the asset smart contract permits the writer host to write at least one first proof value corresponding to the asset into the proof record. In a step 250, the writer host performs calculation on at least one digital file associated with the asset to generate the at least one first proof value, and executes the write function to write the at least one first proof value corresponding to the at least one digital file into the proof record of the asset smart contract. In a step 260, when the verification host receives the digital file associated with the asset, the verification host executes the same proof value conversion manner on the received digital file to calculate at least one second proof value, and outputs a warning message when the at least one second proof value is different from the at least one first proof value. Through aforementioned steps, the smart contract associated with an asset is deployed on the blockchain network 100 through the creator host 110, the proof value of digital file associated with the asset can be aggregated for further verification and management, and the holder host 130 executes the authorization function to set the writer host to be permitted to access the smart contract, the writer host 120 calculates the proof value based on the digital file associated with the asset, and then executes the write function to write the proof value into the proof record of the smart contract, so as to provide the verification host 140 to verify the aggregated proof record.

Furthermore, as shown in FIG. 2C, a step 221 can be executed after the step 220. In the step 221, using the creator host 110 to embed the address of the asset smart contract in an RFID tag, a laser tag, a linear bar code, a two-dimensional barcode, a text, a serial number or a magnetic strip of the asset, so that a verifier can conveniently obtain the address of the asset smart contract for further verification. Furthermore, as shown in FIG. 2D, a step 251 can be executed after the step 250. In the step 251, providing the second writer host 150, which serves as one of the node hosts, to calculate at least one third proof value based on the digital file, and then execute a check function of the asset smart contract to write the third proof value into the asset smart contract as a check record for the verification host 140 to check.

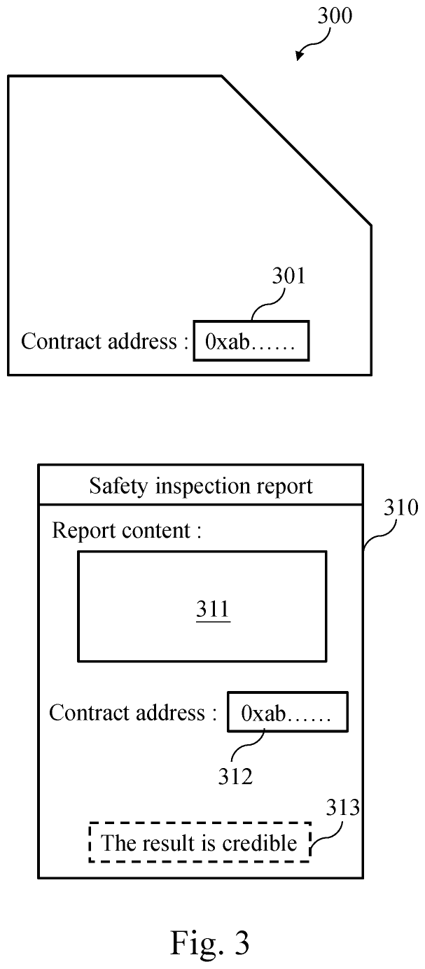

The applications of the present invention are described according to embodiments with reference to FIGS. 3 to 7. Please refer to FIG. 3, which is a schematic view of a first embodiment to which the present invention is applied. In the first embodiment, the asset is a machine 300 and the application scenario is safety inspection and detection before user's operation. In this case, the machine manufacturer uses the creator host 110, the owner of the machine uses the holder host 130, the safety inspector uses the writer host 120, the user of the machine uses the verification host 140, and the digital file is a safety inspection report. The overall process of the first embodiment is described as the following situations.

In a first situation, before or after the machine 300 is produced, the machine manufacturer can use the creator host 110 to create and deploy a smart contract, which is the asset smart contract and associated with the machine. The machine identification information, which is the asset information, can be recorded in the smart contract; for example, the machine identification information can be a machine unique identifier, or the information of the smart contract can be added on the machine 300, as shown in FIG. 3, the information of the smart contract is labelled on an outer shell of the machine 300 by a sticker 301; in another embodiment, the address of the asset smart contract can be embedded in a chip or serial number of the machine 300.

In a second situation, the machine manufacturer assigns itself as the initial asset holder in the smart contract through the creator host 110. When the machine 300 is delivered to a holder of the machine, the holder information of the asset smart contract is also updated to information of the holder, that is, the address of the holder host 130 is written into the holder information of the asset smart contract.

In a third situation, in order to perform safety inspection on the machine, the holder of the machine can call the authorization function of the asset smart contract through the holder host 130, so as to store the address of the writer host 120 into the asset smart contract and set the writable condition; that is, the safety inspector is assigned as the proof writer. For example, the writable condition can include writable times and a write time range, for example, for a plan of monthly safety inspection in a year, the writable condition can include 12 write operations within one year. In this way, when the writable condition is satisfied, the safety inspector is permitted to perform a write operation on the smart contract through the writer host 120.

In a fourth situation, after completing the safety inspection report, the safety inspector generates a proof content based on the digital file conversion format (the proof value conversion manner) regulated in the asset smart contract; for example, the conversion format includes performing coding by Base64 and then executing SHA-256 to perform hash. More specifically, when the digital file is a safety inspection report, the Base64 coding is performed on the digital file of the safety inspection report, and SHA-256 hash calculation is then performed on the coded result, so as to obtain a hash value with a fixed length; the hash value is regards as the first proof value. Next, the write function of the asset smart contract is called through the writer host 120, to write and permanently save the information (such as a unique identifier of the report) and the first proof value corresponding to the safety inspection report into the proof record of the asset smart contract. The write manner is to add new content after the original content.

In a fifth situation, before operating the machine, the user can activate a browse window 310 to read the safety inspection report 311 for the machine, and perform the same proof value conversion manner on the safety inspection report to obtain a second proof value through the verification host 140; next, the user inputs the contract address in an input block 312 to direct to the asset smart contract, and then compares the second proof value and the first proof value recorded in the proof record of the asset smart contract. The proof record includes document information and the corresponding first proof value. When the comparison result indicates that the first proof value and the second proof value are the same, it indicates that no error occurs in the safety inspection report, for example, a display block 313 can show a text of “The result is credible” to indicate that the safety inspection report is credible; when the comparison result indicates that the first proof value and the second proof value are different from each other, display block 313 outputs the warning message indicating that the safety inspection report has error or has been tampered.

It is to be particularly noted that when the asset holder wants to sell the machine 300, the holder can call the transfer function of the asset smart contract through the holder host 130, and the asset holder can change the holder information of the asset smart contract to the address of the node host of a purchaser. After the change is completed, the purchaser becomes the new asset holder and the node host of the purchaser becomes a new holder host 130.

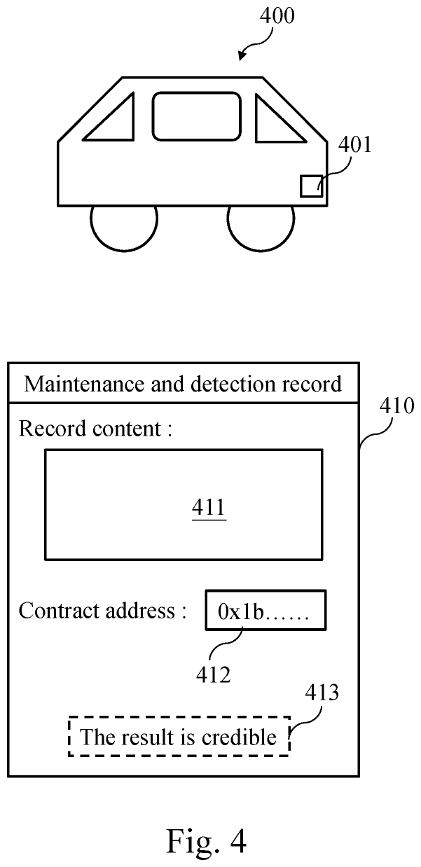

As shown in FIG. 4, which is a schematic view of a second embodiment to which the present invention is applied to. In the second embodiment, the asset is a vehicle 400 and the application scenario includes vehicle maintenance and detection and official inspection. In this case, the vehicle manufacturer uses the creator host 110, the owner of the vehicle (such as a distributor or a vehicle owner) uses the holder host 130, the vehicle maintenance and detection provider uses the writer host 120, the government inspection unit or a vehicle user uses the verification host 140, and the digital file is a maintenance record or a detection record. The overall process of the second embodiment is described as the following situations.

In a first situation, before or after the vehicle 400 is produced, the vehicle manufacturer can use the creator host 110 to create and deploy an asset smart contract associated with the vehicle 400 and record vehicle identification information (such as a vehicle identifier or an engine number) in the asset smart contract; or, contract information can be added on vehicle body, for example, the address of the asset smart contract can be engraved on the tail of vehicle 401 by laser.

In a second situation, the vehicle manufacturer assigns itself as the initial asset holder through the creator host 110. Next, when the vehicle 400 is delivered to the distributor or the vehicle owner, the holder information of the asset smart contract is updated to the information of the distributor or the vehicle owner, that is, the address of the holder host 130 is written into the holder information of the asset smart contract.

In a third situation, in order to perform maintenance and detection on the vehicle, the vehicle owner can call the authorization function of the asset smart contract, and the vehicle owner can assign the maintenance provider or inspection provider as the proof writer and set the writable condition upon the contract, for example, the writable condition can include writable times and a write time range, for example, the writable condition can include one-time write operation within one day or several days for one-time maintenance. Particularly, the vehicle owner can call the authorization function through the holder host 130, to store the address of the writer host 120 into the asset smart contract, so as to permit the writer host 120 to perform the write operation on the asset smart contract, and set the writable times and the write time range.

In a fourth situation, when the proof value conversion manner includes performing Base64 coding and then performing MD5 hash calculation on the coded result, after the maintenance provider or inspection provider completes maintenance or detection for the vehicle, the maintenance provider or inspection provider can perform Base64 coding on the digital file of the maintenance or detection record through the writer host 120, and perform MD5 hash calculation on the coded result to generate a first proof value with a fixed length. Next, the maintenance provider or inspection provider call the write function of the asset smart contract through a writer host 120, to write and permanently save the information (a unique identifier of the record) and the first proof value corresponding to maintenance or detection record in the asset smart contract.

In a fifth situation, before obtaining the vehicle 400, the vehicle owner or the vehicle purchaser can activate the browse window 410 to read the maintenance and inspection record 411 for the vehicle 400, and use the same proof value conversion manner to perform calculation on the record through the verification host 140, so as to generate the corresponding second proof value. Next, the vehicle owner or the vehicle purchaser can input the contract address in the input block 412 to direct to the asset smart contract, and then compare the second proof value with the first proof value corresponding to the proof record of the asset smart contract; for example, the proof record includes document identification information and corresponding first proof value. When the comparison result indicates that the first proof value and the second proof value are the same, it indicates that no error occurs in the maintenance and inspection record, for example, the display block 413 can show a text of “The result is credible” to indicate that the maintenance and inspection record is credible; when the first proof value and the second proof value are different from each other, the display block 413 shows the warning message indicating that the maintenance and inspection record has error or has been tampered.

Besides, in order to sell the vehicle, the distributor or the vehicle owner can call the transfer function of the asset smart contract through the holder host 130, the asset holder can change the holder information of the asset smart contract to the address of the node host of the purchaser; after the change is completed, the purchaser becomes the new asset holder and the node host becomes a new holder host 130.

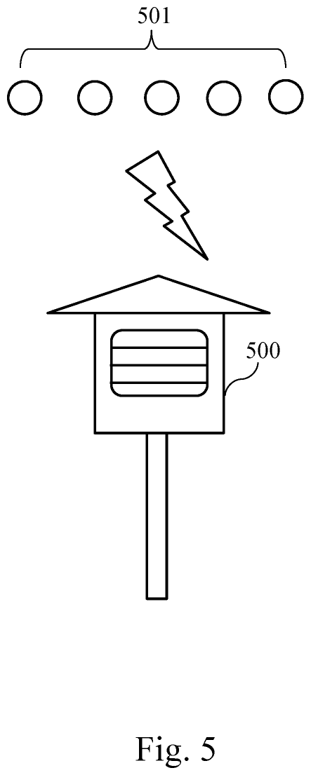

Please refer to FIG. 5, which is a schematic view of a third embodiment to which the present invention is applied. In the third embodiment, the asset is an IoT device 500 and the application scenario is record and detection of the IoT device 500. In this case, the assembler or setter of the IoT device 500 uses the creator host 110, the owner or administrator of the IoT device 500 uses the holder host 130, a sensor 501 of the IoT device 500 uses the writer host 120, the inspector uses the verification host 140, and the digital file is a sensor record. The overall process of the third embodiment is described as the following paragraphs.

In a first situation, before assembling and setting the IoT device, the assembler or setter of the IoT device can create and deploy an asset smart contract associated with the IoT device through the creator host 110, and record device identification information (such as a device unique identifier) in the asset smart contract; or, the contract information can be added on the device, for example, the address of the asset smart contract can be programmed in a memory of the device.

In a second situation, the assembler or the setter of the IoT device can assign itself as the initial asset holder, and when the IoT device is delivered to the device administrator, the holder information of the asset smart contract is updated to the information of the device administrator, that is, the address of the holder host 130 of the device administrator is written into the holder information of the asset smart contract.

In a third situation, before the device is delivered, the assembler or setter of the IoT device can call the authorization function of the asset smart contract through the holder host 130, to store an address of each sensor of the IoT device to the asset smart contract, that is, the sensor of the IoT device is assigned as the proof writer, and the writable times and the write time range can be not limited. Furthermore, when the sensor of the IoT device is replaced, the new sensor of the IoT device is assigned as a new proof writer, that is, the address of the sensor of the IoT device stored in the asset smart contract is updated.

In a fourth situation, when the proof value conversion manner includes performing LZ77 coding (compression algorithm), and after the maintenance provider or inspection provider completes maintenance or detection, the maintenance provider or inspection provider perform LZ77 coding on the digital file (such as the sensor record) generated by the sensor, to generate the first proof value through the writer host 120; at the same time, the sensor of the IoT device calls the write function of the asset smart contract to write and permanently save the information (such as a unique identifier of the record) and the first proof value corresponding to the sensor record to the asset smart contract.

In a fifth situation, in order to read the record, the report viewer or inspector uses the same proof value conversion manner to perform calculation on the sensor record through the verification host 140, so as to generate the second proof value, and then compare the second proof value with the corresponding first proof value of the proof record of the asset smart contract. The proof record includes the identification information and corresponding first proof value. When the comparison result indicates that the first proof value and the second proof value are the same, it indicates that no error occurs in the sensor record; when the first proof value and the second proof value are different from each other, the verification host 140 outputs the warning message indicating that the sensor record has error or has been tampered.

It is to be particularly noted that when the IoT device administrator is changed, the holder host 130 can call the transfer function of the asset smart contract to change the holder information of the asset smart contract to the address of the node host of the new IoT device administrator. After the change is completed, the new IoT device administrator becomes a new asset holder and the node host becomes a new holder host 130. Furthermore, the IoT device can include multiple sensors serving as the writer hosts 120 which write the same asset smart contract, so as to achieve the effect of integrating the monitoring reports of multiple sensors, for example, for a weather detection station, a vehicle (such as a vehicle or an airplane), or hardware equipped with multiple sensors.

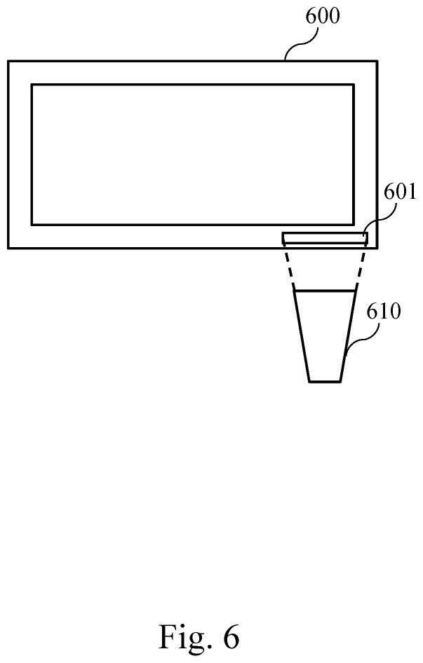

Please refer to FIG. 6, which is a schematic view of a fourth embodiment to which the present invention is applied. In the fourth embodiment, the asset is an artwork, which can include digital format and physical format, and the application scenario is verification or maintain for the artwork. In this case, the author of the artwork or appraisal authority for the artwork uses the creator host 110, the owner of the artwork uses the holder host 130, the appreciator, appraisal unit and maintenance unit use the writer host 120, the valuer for the artwork uses the verification host 140, and the digital file is the record of appreciation, appraisal or maintenance. The overall process of the fourth embodiment is described as the following paragraphs.

In a first situation, before or after the artwork is made, the author of the artwork or the appraisal authority can create and deploy an asset smart contract through the creator host 110, and record artwork identification information (such as artwork characteristic information or unique identifier) in the asset smart contract; or, the contract information can be added on the artwork, for example, for the artwork being a physical painting, the address of the contract can be written into a magnetic strip 601 hidden in the outer frame of artwork 600; for the artwork being a digital painting, the address of the contract can be directly embedded into the digital painting, for example, the address of the contract can be embedded in the file header.

In a second situation, the author of the artwork or appraisal authority assign himself as the initial asset holder through the creator host 110; when the artwork is delivered to a purchaser, the holder of the asset smart contract is updated to the purchaser, and the address of the holder host 130 is written into the holder information of the smart contract.

In a third situation, in order to perform maintenance and appraisal on the artwork, the owner of the artwork calls the authorization function of the asset smart contract, to assign the appraiser, the appreciation authority or the maintenance personnel as the proof writer and set the writable condition upon the contract; for example, the writable condition includes writable times and a write time range, for example, for the one-time appreciation, the writable condition can include one-time write within one day or several days. Particularly, the owner of the artwork calls the authorization function through the holder host 130, to store the address of the writer host 120 into the asset smart contract, so as to permit the writer host 120 to perform the write operation on the asset smart contract, and set the corresponding writable times and write time range.

In a fourth situation, when the proof value conversion manner of the asset smart contract includes performing Base64 coding and then performing hash calculation by the secure hash algorithm 1 (SHA-1), and after the appreciation authority completes appreciation, the appreciation authority can perform Base64 coding on the digital file of appreciation record and then perform SHA-1 hash calculation on the coded result through the writer host 120, so as to generate a first proof value with a fixed length. Next, the appreciation authority can call the write function of the asset smart contract to write and permanently save the information (such as a unique identifier of the appreciation record) and the first proof value corresponding to the appreciation record into the asset smart contract.

In a fifth situation, before starting valuation, the valuer of the artwork can read the record of maintenance or appreciation appraisal for the artwork and then calculate a second proof value for the record by the same proof value conversion manner through the verification host 140. The valuer can use a magnetic sensor 610 to sense the magnetic strip 601 to obtain the address of the asset smart contract, and then compare the second proof value with the corresponding first proof value of the proof record of the asset smart contract. The proof record includes the document identification information and corresponding first proof value. When the first proof value is equal to the second proof value, it indicates that no error occurs in the record of maintenance or appreciation appraisal; when the first proof value and the second proof value are different from each other, the verification host 140 outputs a warning message indicating that the record of maintenance or appreciation appraisal has error or has been tampered.

Similarly, when the owner of the artwork wants to sell the artwork, the owner of the artwork can call the transfer function of the asset smart contract to change the holder information of the asset smart contract to the address of the node host of the purchaser, through the holder host 130. When the change is completed, the purchaser becomes the new asset holder and the node host becomes a new holder host 130.

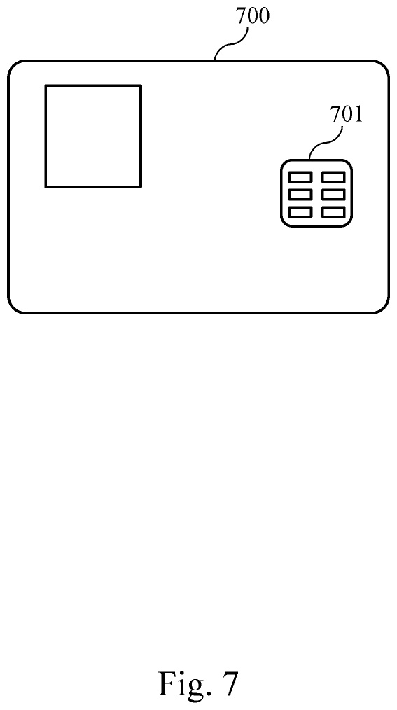

Please refer to FIG. 7, which is a schematic view of a fifth embodiment to which the present invention is applied. In the fifth embodiment, the asset is a healthcare service and the application scenario is seeing a doctor. In this case, the hospital uses the creator host 110, the patient uses the holder host 130, the doctor uses the writer host 120, the insurance officer uses the verification host 140, and the digital file is a medical record. The overall process of the fifth embodiment is described as the following paragraphs.

In a first situation, before a patient sees a doctor, the hospital can create and deploy an asset smart contract, and record identification information (such as ID number) of the patient in the asset smart contract, through the creator host 110; or, the contract information can be written in the health ID card, for example, the address of the contract can be written into a chip 701 of the health ID card 700.

In a second situation, the hospital assigns itself as the initial asset holder through the creator host 110; when the hospital provides the healthcare service to the patient, the holder of the asset smart contract is updated to the patient, that is, the address of the holder host 130 is written into the holder information of the smart contract.

IN a third situation, when the patient visits a doctor, the patient can call the authorization function of the asset smart contract to assign the doctor as the proof writer and set the writable condition upon the contract, for example, the writable condition can include writable times and write time range. Particularly, the patient calls the authorization function to store the address of the writer host 120 of the doctor into the asset smart contract through the holder host 130, so that the writer host 120 is permitted to perform the write operation on the asset smart contract, and the corresponding writable times and write time range can be set.

In a fourth situation, in a condition that the proof value conversion manner of the asset smart contract includes performing encryption by key, after the doctor completes consultation, the doctor encrypts the digital file of medical record to generate the first proof value through the writer host 120. Next, the doctor can call the write function of the asset smart contract to write and permanently save the information (such as a unique identifier of the medical record) and the first proof value corresponding to the medical record into the asset smart contract.

In a fifth situation, when reviewing the medical record, the insurance officer uses the same proof value conversion manner to perform calculation on the medical record, so as to generate a second proof value through the verification host 140, and then compare the second proof value with the corresponding first proof value of the proof record of the asset smart contract. The proof record includes identification information and the first proof value of the medical record. When the comparison result indicates that the first proof value and the second proof value are the same, it indicates that no error occurs in the medical record; when the first proof value and the second proof value are different from each other, the verification host 140 outputs the warning message to indicate that the medical record has error or has been tampered.

According to above-mentioned contents, the difference between the present invention and conventional technology is that in the present invention, the creator host can deploy the smart contract associated with the asset on the blockchain network, so as to aggregate the proof value of the digital file associated with the asset for further verification and management, the holder host can execute the authorization function to set the writer host to be permitted to access the smart contract, and the writer host can calculate the proof value based on the digital file associated with the asset and execute the write function to write the proof value into the proof record of the smart contract, so as to provide the verification host to verify the aggregated proof record. As a result, the technical solution of the present invention can solve the conventional technical problem and achieve the technical effect of improving authenticity and credibility of asset management.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A proof aggregating system for asset management traceability based on blockchain, wherein the proof aggregating system is applied to a blockchain network formed by a plurality of node hosts, and the proof aggregating system comprises:
a creator host serving as one of the plurality of node hosts and comprising:
a deploy module configured to deploy an asset smart contract associated with an asset on the blockchain network through a blockchain transaction, wherein the asset smart contract comprises an authorization function and a write function and configured to record a proof value conversion manner, holder information, and a plurality of proof records; and
a setting module configured to write asset information into the asset smart contract and set an address of the creator host in the holder information, and then update the address recorded in the holder information when the asset is delivered to a holder;
a writer host serving as one of the plurality of node hosts and configured to perform calculation on at least one digital file associated with the asset to generate a first proof value, and then execute the write function to write the first proof value corresponding to the at least one digital file into the proof record of the asset smart contract;
a holder host serving as one of the plurality of node hosts and configured to execute the authorization function to store an address of the writer host into the asset smart contract, and when a preset writable condition is satisfied, the asset smart contract permits the writer host to write the at least one first proof value corresponding to the asset into the proof record; and
a verification host serving as one of the plurality of node hosts and configured to receive the at least one digital file associated with the asset, and execute the same proof value conversion manner on the received digital file, to calculate at least one second proof value, wherein when the second proof value is different from the first proof value, the verification host outputs a warning message.

2. The proof aggregating system for asset management traceability based on blockchain according to claim 1, further comprising a second writer host serving as one of the plurality of node hosts, wherein the second writer host is configured to calculate at least one third proof value based on the digital file, and execute a check function of the asset smart contract to write the at least one third proof value into the asset smart contract as a check record for the verification host to check.

3. The proof aggregating system for asset management traceability based on blockchain according to claim 1, wherein the asset smart contract comprises a transfer function configured to permit the holder host to execute the transfer function, so as to change the holder information recorded in the asset smart contract.

4. The proof aggregating system for asset management traceability based on blockchain according to claim 1, wherein the creator host is configured to embed an address of the asset smart contract in an RFID tag, a laser tag, a linear bar code, a two-dimensional barcode, a serial number or a magnetic strip of the asset.

5. The proof aggregating system for asset management traceability based on blockchain according to claim 1, wherein the proof value conversion manner comprises calculating the digital file by Base64 coding and executing the hash function to perform hash, and based on a size or type or the digital file, selecting one of using raw data, compression algorithm, symmetric encryption, asymmetric encryption and a combination thereof.

6. A proof aggregating method for asset management traceability based on blockchain, wherein the proof aggregating method is applied to a blockchain network formed by a plurality of node hosts, and the proof aggregating method comprises:
providing a creator host, a holder host, a writer host and a verification host, wherein each of the creator host, the holder host, the writer host and the verification host serves as one of the plurality of node hosts;
using the creator host to deploy an asset smart contract associated with an asset on the blockchain network through a blockchain transaction, wherein the asset smart contract comprises an authorization function and a write function, and records a proof value conversion manner, holder information, and a plurality of proof records;
using the creator host to write asset information into the asset smart contract and set an address of the creator host in the holder information, and then update the holder information to an address of the holder host when the asset is delivered to a holder;
using the holder host to execute the authorization function to store an address of the writer host to the asset smart contract, wherein when a preset writable condition is satisfied, the asset smart contract permits the writer host to write at least one first proof value corresponding to the asset into the proof record;
using the writer host to perform calculation on at least one digital file associated with the asset to generate the at least one first proof value, and execute the write function to write the at least one first proof value corresponding to the at least one digital file into the proof record of the asset smart contract; and
when the verification host receives the digital file associated with the asset, using the verification host to execute the same proof value conversion manner on the received digital file to calculate at least one second proof value, and output a warning message when the at least one second proof value is different from the at least one first proof value.

7. The proof aggregating method for asset management traceability based on blockchain according to claim 6, further comprising:
providing a second writer host, which serves as one of the node hosts, to calculate at least one third proof value based on the at least one digital file, and execute a check function of the asset smart contract to write the at least one third proof value into the asset smart contract as a check record for the verification host to check.

8. The proof aggregating method for asset management traceability based on blockchain according to claim 6, wherein the asset smart contract comprises a transfer function, and the holder host is permitted to execute the transfer function to change the holder information recorded in the asset smart contract.

9. The proof aggregating method for asset management traceability based on blockchain according to claim 6, further comprising:
using the creator host to embed an address of the asset smart contract in an RFID tag, a laser tag, a linear bar code, a two-dimensional barcode, a serial number or a magnetic strip of the asset.

10. The proof aggregating method for asset management traceability based on blockchain according to claim 6, wherein the proof value conversion manner comprises calculating the digital file by Base64 coding and executing the hash function to perform hash, and based on a size or type or the digital file, selecting one of using raw data, compression algorithm, symmetric encryption, asymmetric encryption and a combination thereof.
